(19) United States
(12) Patent Application Publication
(10) Pub. No.: US 2013/0287884 A1
(43) Pub. Date: Oct. 31, 2013

(54) Mold-Tool System Including Body Having A Variable Heat Transfer Property

(71) Applicants: Edward Joseph Jenko, Essex, VT (US); Douglas Oliver Hall, Jeffersonville, VT (US)

(72) Inventors: Edward Joseph Jenko, Essex, VT (US); Douglas Oliver Hall, Jeffersonville, VT (US)

(73) Assignee: HUSKY INJECTION MOLDING SYSTEMS LTD., Bolton, ON (CA)

(21) Appl. No.: 13/979,177

(22) PCT Filed: Jan. 6, 2012
(86) PCT No.: PCT/US2012/020397

§ 371 Date: Jul. 11, 2013

Related U.S. Application Data
(60) Provisional application No. 61/431,880, filed on Jan. 12, 2011.

(51) Int. Cl. B29C 45/74

(52) U.S. Cl. CPC B29C 45/74
USPC 425/549

(57) ABSTRACT

A mold-tool system (100) comprising a body (102) defining a melt-transfer channel (104). The body (102) has a variable heat transfer property.

### TECHNICAL FIELD

An aspect generally relates to (but is not limited to) mold-tool systems including (but not limited to) a mold-tool system including a body defining a melt-transfer channel, the body having a variable heat transfer property.

### BACKGROUND

U.S. Pat. No. 6,164,954 discloses an injection nozzle apparatus that includes inner and outer body portions. The inner body portion includes a melt channel and the outer body is made of a pressure resistant material. The ratio between the inner diameter of the outer body portion and the outer diameter of the inner body portion is selected so that a pre-load or a load is generated when assembling the outer body over the inner body. Preferably the assembly of the two bodies is removably fastened to an injection nozzle body. Preferably the inner body includes a material with wear resistant characteristics to withstand abrasive or corrosive molten materials. The apparatus is particularly useful in molding machines and hot runner nozzles for high pressure molding of various materials at normal or elevated injection temperatures.

U.S. Pat. No. 5,208,052 discloses a hot runner nozzle assembly including a mold assembly with a mold cavity therein, an inlet port in the mold assembly communicating with the mold cavity, an injection nozzle for delivering molten resin to the inlet port and an insulating sleeve positioned around the nozzle between the mold assembly and nozzle insulating the nozzle from the mold assembly.

U.S. Pat. No. 5,299,928 discloses a two-piece injection molding nozzle seal. The inner piece through which the melt duct extends is formed of a highly thermally conductive material to enhance heat transfer during the thermodynamic cycle. The surrounding outer retaining piece, which extends from the heated nozzle into contact with the cooled mold to provide the necessary seal, is formed of a substantially less conductive material to avoid undue heat loss.

U.S. Pat. No. 7,241,131 discloses a thick-film electric heater, including: a) a thermally conductive non-flat substrate surface; b) a silk-screened dielectric layer applied on said substrate surface; c) a resistive layer applied on said dielectric layer thereby forming a circuit for the generation of heat, the resistive layer having at least one resistive trace made of thick film ink in a pattern that is discontinuous circumferentially; d) at least a pair of silk-screened contact pads applied in electrical communication with said resistive layer for electrical connection to a power source; e) an insulation layer applied over said resistive layer; and f) wherein the thermally conductive non-flat substrate surface has a thermal coefficient of expansion substantially the same or slightly lower than the dielectric and resistive layers.

U.S. Pat. No. 7,108,503 discloses a nozzle for an injection molding apparatus is provided. The injection molding apparatus has a mold component that defines a mold cavity and a gate into the mold cavity. The nozzle includes a nozzle body, a heater, a tip, a tip surrounding piece, and a mold component contacting piece. The nozzle body defines a nozzle body melt passage therethrough that is adapted to receive melt from a melt source. The heater is thermally connected to the nozzle body for heating melt in the nozzle body. The tip defines a tip melt passage therethrough, that is downstream from the nozzle body melt passage, and that is adapted to be upstream from the gate. The tip surrounding piece is removably connected with respect to said nozzle body. The mold component contacting piece is connected with respect to the nozzle body. The material of the mold component contacting piece has a thermal conductivity that is less than at least one of the thermal conductivity of the material of the tip and the thermal conductivity of the material of the tip surrounding piece.

European Patent Number 1302295 discloses a nozzle heater that includes a dielectric film layer and a resistive thick film layer applied directly to the exterior cylindrical surface of the nozzle by means of precision thick film printing. The thick film is applied directly to the nozzle body, which increases the nozzle's diameter by only a minimal amount. Flexibility of heat distribution is also obtained through the ability to apply the heater in various patterns and is, thus, less limited than spiral designs. Specifically, a surface layer is a layer of a metal having a higher thermal conductivity than steel nozzle body, such as copper and alloys of copper. Surface layer thus promotes a more even distribution of heat from heater assembly to the pressurized melt in central melt bore. Surface layer may be applied by spraying or by shrink-fitting a sleeve on core. Surface layer may have a thickness of between 0.1 mm to 0.5 mm, or greater if desired.

United States Patent Publication Number 20020054932 discloses a nozzle heater that includes a dielectric film layer and a resistive thick film layer applied directly to the exterior cylindrical surface of the nozzle by means of precision thick film printing. The thick film is applied directly to the nozzle body, which increases the nozzle's diameter by only a minimal amount. Flexibility of heat distribution is also obtained through the ability to apply the heater in various patterns and is, thus, less limited than spiral designs.

U.S. Pat. No. 4,897,150 discloses a method of direct write desposition of a conductor on a semiconductor. Direct write techniques have been developed wherein, for example, an electron beam “writes” a pattern in photoresist on an integrated circuit or other semiconductive element. Some of these prior direct write techniques have also included the use of laser beams. Such laser assisted deposition techniques involve the deposition of metal from an organometallic gas or polysilicon from silane (SiH4).

U.S. Pat. No. 7,001,467 discloses a device and method for depositing a material of interest onto a receiving substrate includes a first laser and a second laser, a receiving substrate, and a target substrate. The target substrate comprises a laser transparent support having a back surface and a front surface. The front surface has a coating that comprises the source material, which is a material that can be transformed into the material of interest. The first laser can be positioned in relation to the target substrate so that a laser beam is directed through the back surface of the target substrate and through the laser-transparent support to strike the coating at a defined location with sufficient energy to remove and lift the source material from the surface of the support. The receiving substrate can be positioned in a spaced relation to the target substrate so that the source material is deposited at a defined location on the receiving substrate. The second laser is then positioned to strike the deposited source material to transform the source material into the material of interest. A conducting silver line was fabricated by using a UV laser beam to first transfer the coating from a target substrate to a receiving substrate and then post-processing the transferred material with a second IR laser beam. The target substrate consisted of a UV grade fused silica disk of 2″ diameter and approx. ⅛ 41 thickness on which one side was coated with a layer of the material to be transferred. This layer consisted of Ag powder (particle size of a few microns) and a metalloorganic precursor, which decomposes into a conducting specie(s) at low temperatures (less than 200° C.). The receiving substrate was a microwave-quality circuit board, which has various gold electrode pads that are a few microns thick. A spacer of 25-micron thickness was used to separate the target and receiving substrates. Silver was first transferred with a focused UV (λ=248 nm or λ=355) laser beam through the target substrate at a focal fluence of 225 mJ/cm2. The spot size at the focus was 40 μm (micrometers) in diameter. A line of “dots” was fabricated between 2 gold contact pads by translating both the target and receiving substrates together to expose a fresh area of the target substrate for each laser shot while the laser beam remained stationary. The distance between the laser spots was approx. one spot diameter. A pass consisted of approximately 25 dots and a total of 10 passes (superimposed on one another) was made. The target substrate was moved between each pass. After the transfers, the resistance between the gold pads as measured with an ohmmeter was infinite (>20-30 Mega ohms).

U.S. Pat. No. 7,014,885 discloses a pyrolytic laser CVD involves essentially the same mechanism and chemistry as conventional thermal CVD, and it has found major use in direct writing of thin films for semiconductor applications. It is an object of the to provide a device and method that is useful for creating a deposit of electrically conducting material by depositing a precursor material or a mixture of a precursor material and an inorganic powder that is transformed into an electrical conductor. For creating deposits of metals, such as for conductor lines, any precursors commonly used in chemical vapor deposition (CVD) and laser-induced chemical vapor depositon (LCVD) may be used. Examples include, but are not limited to, metal alkoxides, metal diketonates and metal carboxalates.

U.S. Pat. No. 5,132,248 discloses direct write with microelectronic circuit fabrication. In a process for deposition of material onto a substrate, for example, the deposition of metals or dielectrics onto a semiconductor laser, the material is deposited by providing a colloidal suspension of the material and directly writing the suspension onto the substrate surface by ink jet printing techniques. This procedure minimizes the handling requirements of the substrate during the deposition process and also minimizes the exchange of energy between the material to be deposited and the substrate at the interface. The deposited material is then resolved into a desired pattern, preferably by subjecting the deposit to a laser annealing step. The laser annealing step provides high resolution of the resultant pattern while minimizing the overall thermal load of the substrate and permitting precise control of interface chemistry and interdiffusion between the substrate and the deposit.

U.S. Pat. No. 5,741,557 discloses a method for depositing metal fine lines on a substrate. A method for forming a desired pattern of a material of conductive or non-conductive type on a variety of substrates is described. It is based on the use of a pen, which essentially consists of a refractory tip wetted with the material in the molten state. The pen preferably consists of a pointed tungsten tip attached to the top of a V-shaped tungsten heater, forming a heater assembly. The tip and the heater top portion are roughened at the vicinity of the welding point. In turn, the ends of the V-shaped heater are welded to the pins of a 3-lead TO-5 package base. The pen is incorporated in an apparatus adapted to the direct writing technique. To that end, the pen is attached to a supporting device capable of movements in the X, Y and Z directions, while the substrate is placed on an X-Y stage for adequate X, Y and Z relative movements therebetween. The two pins of the pen are connected to a power supply to resistively heat the heater. When the welding point of the tip/heater assembly reaches the melting point of the material to be deposited, it is dipped in a crucible containing the material in the molten state. The welding point nucleates a minute drop of the liquid material, thus forming a reservoir. A thin film of the liquid material flows from the reservoir and wets the tip. Finally, the wetted tip is gently brought into contact with the substrate and deposition of the material takes place to produce the desired pattern.

### SUMMARY

The inventors have researched a problem associated with known molding systems that inadvertently manufacture bad-quality molded articles or parts. After much study, the inventors believe they have arrived at an understanding of the problem and its solution, which are stated below, and the inventors believe this understanding is not known to the public. Within an injection molding hot-runner tool, otherwise which may be called a mold-tool system, it may be necessary to provide heat to a melt-transfer channel. The melt-transfer channel may be used to transfer a resin from a pellet stage to a part cavity of a mold assembly. During the transfer of the resin, heat may be added at convenient locations along the melt-transfer channel. The added heat may create thermal gradients within the melt-transfer channel, and the added heat may not always provide the desired heat at the desired location. This is partly determined by the thermal conductivity of the component's base material. The thermal gradient may result in undesirable heat treatment of the resin. And more specifically, the thermal gradient may not provide the desired heat transfer to other components in contact with the melt-transfer channel.

Known components associated with known mold-tool systems (which are not depicted) may have or include multiple materials that are manufactured using conventional means such as press fitting, welding and brazing of the known components. The placement of a heat source may create a hot spot in close proximity to the heat source, and the material properties may not transfer the desired heat to the area of interest. More specifically, in a side gated hot runner, it may be desired to transfer heat from a nozzle housing to a molding tip, which in of itself may not have a heat source.

According to one aspect, there is provided a mold-tool system (100), comprising a body (102) defining melt-transfer channel (104), the body (102) having a variable heat transfer property.

Other aspects and features of the non-limiting embodiments will now become apparent to those skilled in the art upon review of the following detailed description of the non-limiting embodiments with the accompanying drawings.

### DETAILED DESCRIPTION OF THE DRAWINGS

The non-limiting embodiments will be more fully appreciated by reference to the following detailed description of the non-limiting embodiments when taken in conjunction with the accompanying drawings, in which:

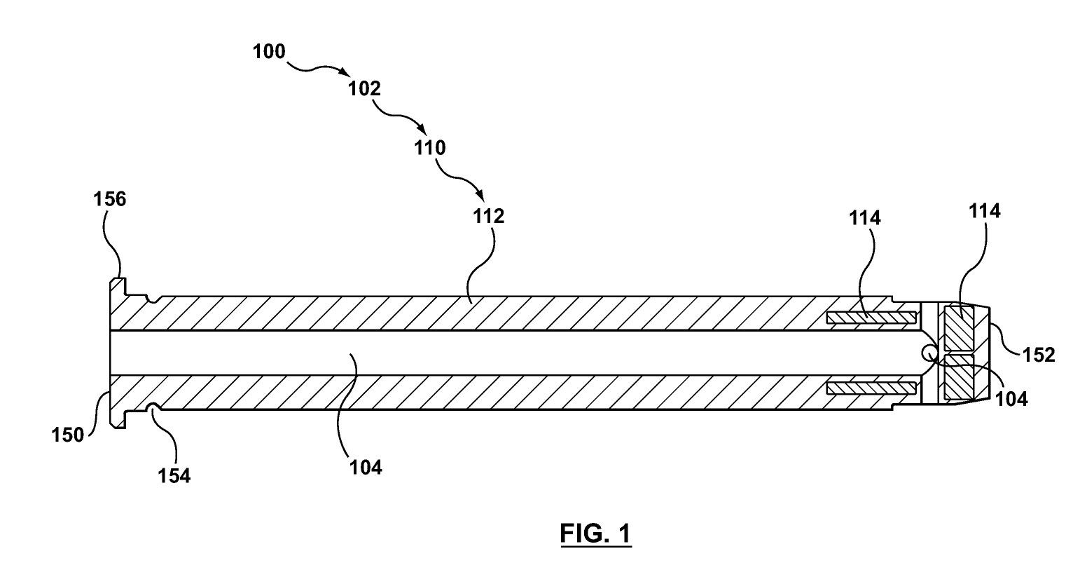

FIGS. 1, 2, 3 depict schematic representations of a mold-tool system (100).

The drawings are not necessarily to scale and may be illustrated by phantom lines, diagrammatic representations and fragmentary views. In certain instances, details not necessary for an understanding of the embodiments (and/or details that render other details difficult to perceive) may have been omitted.

### DETAILED DESCRIPTION OF THE NON-LIMITING EMBODIMENT(S)

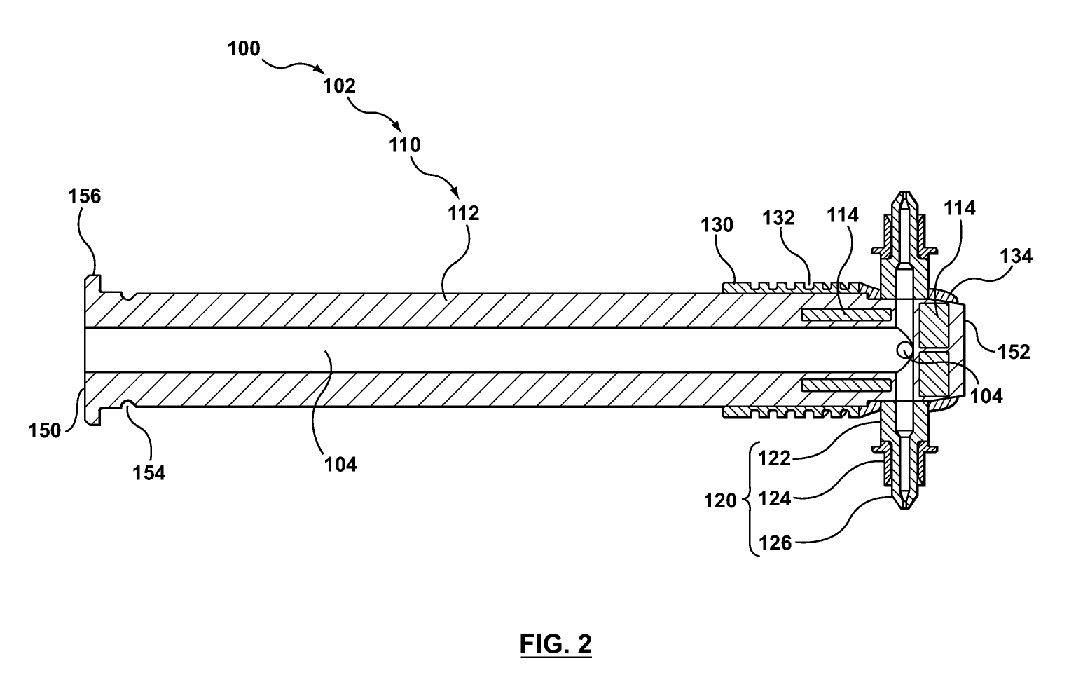

FIGS. 1 and 2 depict examples of the schematic representations of the mold-tool system (100). The mold-tool system (100) may be used in a runner assembly, such as a hot runner system (known, not depicted). The mold-tool system (100) may also be used in an injection molding system (known but not depicted). The mold-tool system (100) may include components that are known to persons skilled in the art, and these known components will not be described here; these known components are described, at least in part, in the following reference books (for example): (i) “Injection Molding Handbook” authored by OSSWALD/TURNG/GRAMANN (ISBN: 3-446-21669-2), (ii) “Injection Molding Handbook” authored by ROSATO AND ROSATO (ISBN: 0-412-99381-3), (iii) “Injection Molding Systems” 3^{rd} Edition authored by JOHANNABER (ISBN 3-446-17733-7) and/or (iv) “Runner and Gating Design Handbook” authored by BEAUMONT (ISBN 1-446-22672-9). It will be appreciated that for the purposes of this document, the phrase “includes (but is not limited to)” is equivalent to the word “comprising.” The word “comprising” is a transitional phrase or word that links the preamble of a patent claim to the specific elements set forth in the claim, which define what the invention itself actually is. The transitional phrase acts as a limitation on the claim, indicating whether a similar device, method, or composition infringes the patent if the accused device (etc) contains more or fewer elements than the claim in the patent. The word “comprising” is to be treated as an open transition, which is the broadest form of transition, as it does not limit the preamble to whatever elements are identified in the claim.

FIG. 1 depicts a schematic representation (specifically, a cross-sectional view) of a first example of the mold-tool system (100).

FIG. 2 depicts a schematic representation (specifically, a cross-sectional view) of a second example of the mold-tool system (100).

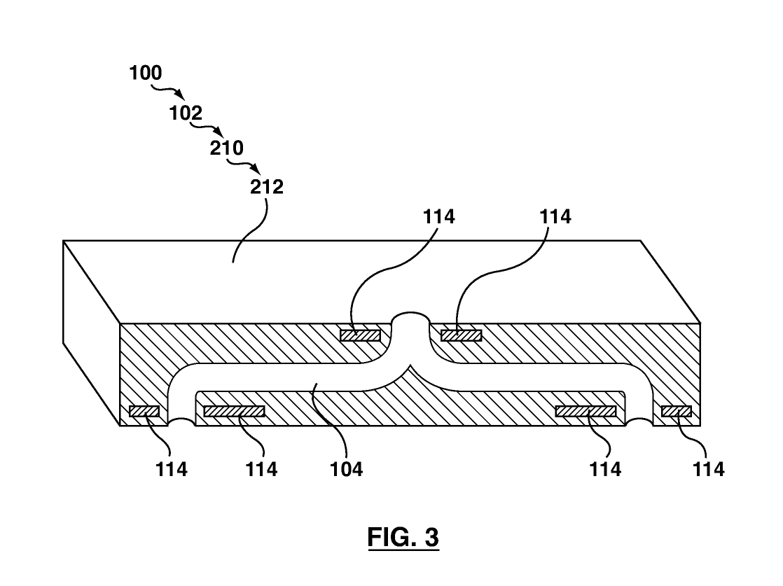

FIG. 3 depicts a schematic representation (specifically, a cross-sectional view) of a third example of the mold-tool system (100).

Generally speaking, the mold-tool system (100) may include, by way of example (and not limited to) the following: a body (102) that defines a melt-transfer channel (104), and the body (102) has a variable heat transfer property. The mold-tool system (100) is a system that is positioned and/or is used within an envelope defined by a platen system of a molding system (such as an injection molding system). The platen system may include a stationary platen and a movable platen that is moveable relative to the stationary platen. Examples of the mold-tool system (100) may include (and is not limited to): a hot runner system, a cold runner system, a runner nozzle, a manifold system, and/or any sub-assembly or part thereof.

By way of a more specific example, the mold-tool system (100) may be adapted so that the body (102) includes a nozzle assembly (110) that has a nozzle housing body (112), the nozzle housing body (112) defines the melt-transfer channel (104), and the nozzle assembly (110) has the variable heat transfer property.

A way to manufacture the mold-tool system (100) may be to produce the body (102) such that the body (102) includes a single component that has the heat transfer property that is positioned at selected locations of the body (102). This may be accomplished with a layer-machining process, such as 3D printing, etc, by introducing materials that have either more thermal conductivity or less thermal conductivity within a base material used to produce the body (102).

For example, in a side gate nozzle configuration (as depicted in FIG. 2), it may be desirable to reduce the thermal conductivity behind a front heater, and to increase the thermal conductivity in front of the front heater. By using a base housing material of lower thermal conductivity and embedding a high thermal conductivity material in the front of the body (102), the heat flow from the front heater will be arrested in the direction of a manifold assembly (known, not depicted and to be positioned at the rear end of the nozzle housing body (112)), and may be accelerated to an area in contact with a molding tip and/or molding tips.

By way of example, an alternative manufacturing configuration may be used in which different materials are not required to be embedded within a base material but may be effectively welded together in sections during the layer machining process, thus providing the desired heat flow to the various sections of the body (102).

The body (102) is not limited or restricted to the nozzle housing body (112). The body (102) may include, by way of another example, a molding tip assembly (120) and the molding tip assembly (120) has the variable heat transfer property. The body (102) may include any components of a runner system (either a hot runner or a cold runner).

An example of the layer manufacturing may include (and is not limited to) a 3D printing process. There are many suppliers of equipment to produce metallic final parts with varying capabilities and many of these companies also have the raw materials with varying properties.

Turning to FIG. 1, by way of example, the nozzle housing body (112) may include (and is not limited to): a rear portion (150) and a front portion (152) set apart from the rear portion (150). The melt-transfer channel (104) extends from the rear portion (150) to the front portion (152). The rear portion (150) is positionable adjacent to a manifold assembly (known and not depicted) or a runner system (known and not depicted). The front portion (152) is positionable adjacent to a mold assembly (known and not depicted). A housing flange (156) may extend axially from the rear portion (150). A stress-relieving feature (154) may be positioned near or proximate to the rear portion (150). A material (114) having a thermal conductivity being different from the body (102) may be positioned proximate to the melt-transfer channel (104), such as: (i) at a position being proximate to the front portion (152), or (ii) at a position that is set apart from the rear portion (150).

Turning to FIG. 2, by way of example, a heater assembly (130) may be positioned on the body (102). The heater assembly (130) may define a groove (132) that is configured to receive a heating element (not depicted and known). A heat finger (134) may extend from the heater assembly (130) toward the front portion (152). The molding tip assembly (120) may include (and is not limit to): a tip wear ring (122), a tip seal ring (124), and a side gated tip (126). The molding tip assembly (120) may extend from the body (102) and may be in fluid communication with the melt-transfer channel (104).

Turning now to FIG. 3, by way of example, the mold-tool system (100) may be configured and/or adapted such that the body (102) includes (and is not limited to): a manifold assembly (210) that may have a manifold body (212). The manifold body (212) may define the melt-transfer channel (104). The manifold assembly (210) may have the variable heat transfer property. More specifically, the material (114) has a thermal conductivity that may be different from the manifold body (212). The material (114) may be positioned proximate to the melt-transfer channel (104), such as the positioned depicted in FIG. 3, such as (for example) at the entrances and/or the exists of the manifold body (212).

It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) description provided outside of this document (that is, outside of the instant application as filed, as prosecuted, and/or as granted). It is understood, for the purposes of this document, the phrase “includes (and is not limited to)” is equivalent to the word “comprising.” It is noted that the foregoing has outlined the non-limiting embodiments (examples). The description is made for particular non-limiting embodiments (examples). It is understood that the non-limiting embodiments are merely illustrative as examples.

What is claimed is:

1. A mold-tool system (100), comprising:
a body (102) defining a melt-transfer channel (104); and
a material (114) having a thermal conductivity being different from a thermal conductivity of the body (102);
the material (114) being embedded within the body (102), the body (102) thereby having a variable heat transfer property.

2. The mold-tool system (100) of claim 1, wherein:
the body (102) includes a nozzle assembly (110) having a nozzle housing body (112),
the nozzle housing body (112) defines the melt-transfer channel (104), and
the nozzle assembly (110) has the variable heat transfer property.

3. The mold-tool system (100) of claim 1, wherein:
the body (102) includes a molding tip assembly (120), and the molding tip assembly (120) has the variable heat transfer property.

4. The mold-tool system (100) of claim 1, wherein:
the body (102) includes a manifold assembly (210) having a manifold body (212),
the manifold body (212) defines the melt-transfer channel (104), and
the manifold assembly (210) has the variable heat transfer property.

5. A nozzle assembly (110), comprising:
a heater assembly (130);
a nozzle housing body (112) defining a melt-transfer channel (104), the nozzle housing body (112) including:
a rear portion (150), and
a front portion (152) set apart from the rear portion (150); and
a material (114) having a thermal conductivity being relatively higher than a thermal conductivity of the nozzle housing body (112);
the heater assembly (130) being located on the nozzle housing body (112) between the rear portion (150) and the front portion (152), and the nozzle housing body (112) having the material (114) embedded therein at the front portion (152), the nozzle housing body (112) thereby having a variable heat transfer property.

6. A manifold assembly (210), comprising:
a manifold body (212) defining a melt-transfer channel (104), at least one entrance, and at least one exit; and
a material (114) having a thermal conductivity being different from a thermal conductivity of the manifold body (212);
the material (114) being embedded within the manifold body (212) at the at least one entrance and/or at least one exit to the manifold body (212), the manifold body (212) thereby having a variable heat transfer property.
